(19) United States
(12) Patent Application Publication
(10) Pub. No.: US 2005/0108106 A1
(43) Pub. Date: May 19, 2005

(54) System and method for coordination of delivery of marketing material

(76) Inventors: Warren Lloyd Tomlin, Carleton Place (CA); Joshua Patrick Leroux, Ottawa (CA)

Correspondence Address: SMART & BIGGAR/FETHERSTONHAUGH & CO.;P.O. BOX 2999, STATION D, 900-55 METCALFE STREET, OTTAWA, ON, K1P5Y6, CA

(21) Appl. No.: 10/986,762

(22) Filed: Nov. 15, 2004

Related U.S. Application Data
(60) Provisional application No. 60/519,613, filed on Nov. 14, 2003.

(51) Int. Cl. G06F 17/60

(52) U.S. Cl. 705/26

(57) ABSTRACT

Web-based delivery of marketing material is co-ordinated by allowing content servers to deliver web content in which is embedded GUI elements that point to independently provided infrastructure. This infrastructure has an application that is downloaded to user devices upon selection of the GUI element. The application presents to the user a set of available options for delivery of materials associated with an offer selected from within the content provided by the content server.

### RELATED APPLICATION

This application claims the benefit of prior U.S. provisional application No. 60/519,613 filed Nov. 14, 2003.

### FIELD OF THE INVENTION

This invention relates generally to marketing and, in particular, to the delivery of marketing materials.

### BACKGROUND OF THE INVENTION

Marketing activities such as advertising are of primary importance for distribution of product and service related communications to consumers. These communications range from information on the products and services themselves to product samples and service trial periods, for example. Achieving greater effectiveness from the significant costs of these activities is a vital challenge to marketers in their efforts to promote their goods or services in the marketplace, to acquire new customers, to build loyalty by retaining existing customers and fostering positive customer relationships, and to increase sales. Marketers generally prefer to build one-to-one relationships with customers to get the right information, and eventually products or services, into the right hands at the right time.

Marketers deliver information to their customers through a variety of media. Television and daily newspapers are currently two of the most popular advertising media. However, while these large, traditional media have historically captured a major proportion of advertising expenditures, newer media such as the Internet are rapidly increasing in popularity. Other alternative marketing approaches, including relationship marketing such as through sponsoring and partnering, telemarketing, and direct mailing, for example, are also used by marketers to enhance the reach of their campaigns.

Each advertising medium has its own benefits and drawbacks. For example, a pet food manufacturer may wish to identify and build a close relationship with dog owners in order to provide each owner with information on an appropriate dog food formula as a dog ages. While this marketer uses media that are expected to reach the targeted segments of the population, namely dog owners, most effectively, an advertising broadcast often reaches other segments of the population that may have no need for or interest in pet foods. As such, the advertising message “slips” toward many uninterested consumers.

The volume of undesired advertising that reaches a hostile audience is epic, and is unintentionally resulting in a consumer backlash against advertising. Features and services that let the consumer filter out advertising or receive only the messages they want are gaining a broad acceptance. For example, many e-mail programs provide filters that identify and either delete or divert received unsolicited “spam” or “junk” e-mail messages from a user's e-mail Inbox. Software that allows users to block pop-up and pop-under ads are also becoming more common.

To an increasingly demanding and sophisticated consumer, the means by which marketers can currently get their messages out are rapidly being rendered ineffective. Thus, they fall short of what marketers hope to achieve. The consumer wants control over what he or she receives, while the marketer needs to get a message to both desiring and merely desirable target consumers. The message must also be specifically and generally meaningful: a troubling paradox.

One significant shortcoming of known advertising techniques is the lack of media interactivity. Media are used in a somewhat co-ordinated but disjointed way. They remain distinct and separate channels with limited interaction. This is inherently inadequate, as the marketer cannot fully co-ordinate a strategic program maximizing the full breadth of its targets' media utilization.

Conventional advertising is also prone to information latency and delayed feedback. Marketing communications typically involve a rapid one-way message by the marketer with a potential for indirect, slow, and often inferred response from the user. Information latency due to this slow and cumbersome feedback loop results in sub-optimal effectiveness measurement alternatives. The opportunity for real-time campaign refinement is all but non-existent.

Many advertising media, excepting point-of-purchase and some specialty media, do not lend themselves to consumer impulsiveness. Making a marketing communication meaningful to a customer at a time when he or she can act immediately or impulsively may be valuable to marketers.

Marketers use and gauge success of media and campaigns by measuring returns on investment, normally using benchmarks for reach, acquisition cost, retention cost, etc. Collection of these types of information for advertising tends to be expensive and not very timely. The immediacy, accuracy, and relevancy values for these measures are high for aggregated-campaign-level metrics, but lower for addressing specific key factors and causalities. Lower cost, more timely measures of market response may be more valuable for tactical decision-making.

On the consumer side, consumers often want broader access to information, more focused and timely messages, and more control over the information received. As noted above, much advertising is increasingly provoking negative consumer reaction from frustration and annoyance with unwanted and in some cases invasive advertising. Consumer negative reaction to advertising may be due, at least in part, to a failure of conventional advertising schemes to satisfy evolving consumer needs.

For example, a consumer usually has limited options for dealing with interesting advertising messages in a meaningful and timely way due to the nature of most marketing communications. Often, the burden is on the consumer to remember the message and address it later when they have the means to do so. However, the relevance of the advertising diminishes over time, as does the satisfaction with a product when the process for obtaining information and ultimately purchasing it becomes burdensome.

Even consumers that are gathering information may wish to remain anonymous until they choose to engage the marketer in order to avoid receiving unwanted materials through direct marketing campaigns, for example. Obtaining material from a marketer by mail or via an e-mail request creates an address bridge that often allows further unsolicited communication. Many consumers avoid interaction where they cannot control the consent to communicate. As mentioned briefly above, a consumer is often unable to easily and quickly respond to an ad in a convenient and desirable way.

Limited delivery and response options further degrade advertising effectiveness. Marketers typically broadcast messages to the consumer, and the options for responding in a way valuable either to the consumer or to the marketer are severely limited. Even where multiple delivery options for subsequent marketing communications such as brochures and free samples are provided, known mechanisms for user selection of a delivery option tends to be cumbersome.

### SUMMARY OF THE INVENTION

According to one broad aspect, the invention provides a system comprising: application server infrastructure adapted to deliver an application over a network for execution on a user device; a customer information store adapted to maintain details of a respective set of at least one delivery option for each of a plurality of customers; an offer information store adapted to maintain a respective set of possible delivery options for each of a plurality of offers; wherein the application, upon being delivered to the user device, presents on the user device a set of at least one delivery option, the set of at least one delivery option being determined using the set of possible delivery options for a selected offer and the set of at least one delivery options for the customer, collects a selection of one of the at least one delivery options and returns this selection to the application server infrastructure.

In some embodiments, the system is provided in combination with a plurality of content servers for delivering on-line content to customers using user devices via a network, the on-line content comprising at least one offer of said plurality of offers, each offer comprising a selectable reference to the infrastructure that upon selection obtains the application from the infrastructure.

In some embodiments, the plurality of content servers are on a plurality of different domains.

In some embodiments, the application is a Flash™ or Flash-like application.

In some embodiments, the system further comprises: a registration interface through which a customer registers with the system, is given access parameters and can input details of their delivery options.

In some embodiments, the registration interface is part of the application.

In some embodiments, the available delivery options comprise: physical delivery to a postal address; delivery to an e-mail address.

In some embodiments, the system comprises: a login function adapted to collect and authenticate access parameters.

In some embodiments, the application is further adapted to maintain local data such that subsequent operations do not require a repeat login operation.

In some embodiments, the local data comprises a token having an expiry time.

In some embodiments, the system further comprises: fulfilment infrastructure adapted to perform a delivery in accordance with the selected offer and the selected delivery option.

In some embodiments, the system is adapted to generate an order identifying the offer and delivery details and to forward this to an external fulfilment capability.

In some embodiments, each selectable reference has an associated identifier that indexes into the offer information store.

In some embodiments, the offer information store further comprises a respective set of rules for each offer, the system being adapted to apply the set of rules of a given offer when processing the offer.

In some embodiments, at least one set of rules includes at least one rule selected from a group consisting of: maximum number of fulfilments to a given address; different fulfilments to different postal codes.

According to another broad aspect, the invention provides a computer executable method comprising: storing details of a respective set of at least one delivery option for each of a plurality of customers; storing a respective set of possible delivery options for each of a plurality of offers; receiving from a particular customer an input specifying a selected offer; determining a set of at least one delivery options in respect of the selected offer and the particular customer; delivering an application over a network for execution on the user device that when executed presents the set of at least one delivery options in respect of the selected offer and the particular customer; receiving a selection of one of the at least one delivery options.

In some embodiments, the computer executable method further comprises: determining the particular user through a login procedure.

In some embodiments, the application is a Flash™ or Flash-like application.

In some embodiments, the computer executable method further comprises: presenting a registration interface through which a customer registers, and can input details of their delivery options.

In some embodiments, the computer executable method further comprises the application maintaining local session data a such that after successful login subsequent operations do not require a repeat login operation.

In some embodiments, the computer executable method is further adapted to generate an order identifying the offer and the delivery details, and to forward this to an external fulfilment capability.

In some embodiments, the computer executable method further comprises storing a respective set of rules for each offer, and applying the set of rules of a given offer when processing each offer.

In some embodiments, a computer readable medium is provided having processor executable instructions stored thereon for implementing any method as summarized above.

### BRIEF DESCRIPTION OF THE DRAWINGS

FIG. 1 is a block diagram of a system for the of co-ordinating delivery of marketing material provided by an embodiment of the invention;

FIG. 2 is a flowchart of a method of co-ordinating delivery of marketing materials that might be implemented using the system of FIG. 1;

FIG. 3 is an example data structure for customer information;

FIG. 4 is an example data structure for offer information;

FIG. 5 is an example of a site map that might be used to implement an application provided by an embodiment of the invention;

FIGS. 6A and 6B show example screen displays for a welcome page;

FIG. 7 shows an example screen display for alternative methods of accessing offers through the application;

FIGS. 8A through 8D provide example display screens for registration;

FIG. 9 shows example display screens for selecting one of a set of available delivery options for a particular offer by a particular customer; and

FIG. 10 shows an example display screen containing multiple GUI elements each associated with respective offers.

### DETAILED DESCRIPTION OF THE PREFERRED EMBODIMENTS

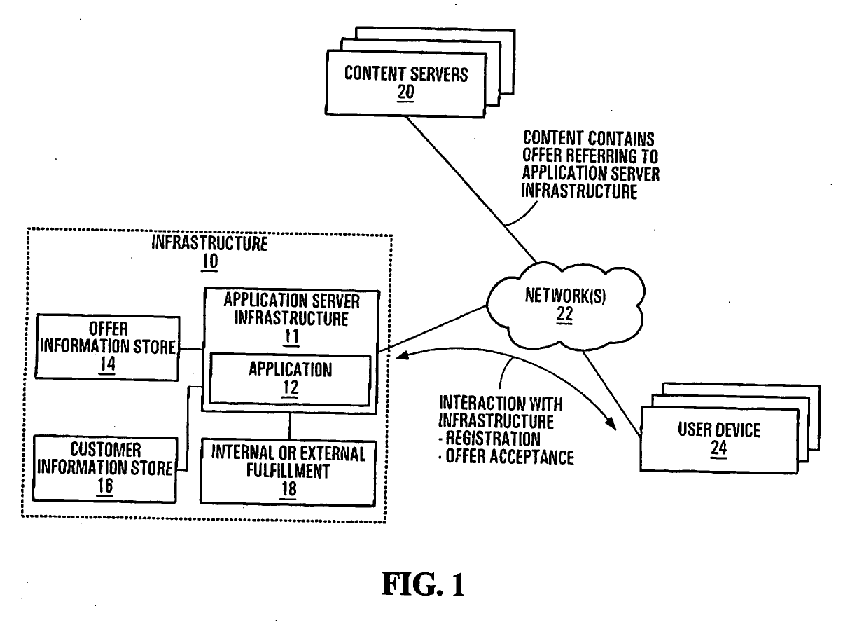

FIG. 1 is a block diagram of a high level view of a system for the co-ordination of the delivery of marketing materials. Shown are infrastructure, generally indicated by 10, content servers 20, and user devices 24 connected through one or more networks 22. The content servers 20 provide on-line content to the user devices 24. For example, the content servers 20 may serve up web content over the public internet to user devices 24. As is well known in such a context, a given user device 24 is able to navigate through the internet to obtain the content from a selected content server. For the purpose of this embodiment of the invention, the content that is delivered to the user device 24 contains an offer or offers that refer to an application server infrastructure 11 forming part of the infrastructure 10. Each content server 20 that is to participate in the co-ordination of the delivery of marketing materials will have one or more offers contained in the content that is made available to the user devices 24.

The offer is presented to the user in the form of a selectable GUI (graphical user interface) element associated with the offer. This might for example be an icon or logo that is displayed on the screen of the user device 24 together with text indicating what the offer is. The content delivered to the user device 24 from a given content server 20 contains functionality that interprets a selection of the GUI element by directing the user device 24 to launch an application 12 from the application server infrastructure 11 of the infrastructure 10.

Turning now to further details of the infrastructure 10, as indicated above this includes application server infrastructure 11 which is adapted to deliver an application 12 to user devices 24. In a preferred embodiment, the application 12 is a Flash™ application that is capable of being run concurrently with and over top of content being provided by the content servers 20. The application server infrastructure 11 is also connected to an offer information store 14 and a customer information store 16. The offer information store maintains a set of possible delivery options for each of the available offers. The offer information store may include further information pertaining to each offer as detailed below.

As indicated previously, preferably the application is a Flash application or a Flash-like application. More generally, the application is preferably an application that provides rich interactive media. The application may be browser plug-in-based or may execute on a client device such as a mobile phone or PDA that does not rely on a browser, using technologies such as BREW or Java 2 Micro Edition (J2ME). If the application runs on a client device such as a mobile phone or PDA, it may have less functionality than a full desktop device due to the nature of the client device with regards to screen display and peripherals. It might for example be an application in Active X controls, JavaScript, Flex, Xforms or Shockwave to name a few other examples.

The customer information store 16 maintains details of a set of at least one delivery option for each customer that might use one of user devices 24. Further details of the customer information store are provided below.

User devices 24 interact with the infrastructure 10 to launch the application 12, and in some embodiments to perform registration and offer acceptance.

The infrastructure 10 also shows internal or external fulfilment functionality 18. In some embodiments, the infrastructure 10 is responsible for the actual delivery the marketing material in which case internal fulfilment is performed. However, in other embodiments, the infrastructure 10 simply generates an order that is then forwarded to an appropriate external fulfilment capability not forming part of the infrastructure.

Depending upon the nature of the networks 22, the content servers 20 may be co-located or located in completely different locations. Typically, different advertisers will have their own content servers that will be located separately. For web-based implementations, any server that is connected to the public internet can be employed to deliver content to user devices also connected to the internet, the contents containing an offer referring to the application server infrastructure 11. Thus, user devices 24, for web-based implementations, can be any device capable of accessing the internet in this manner.

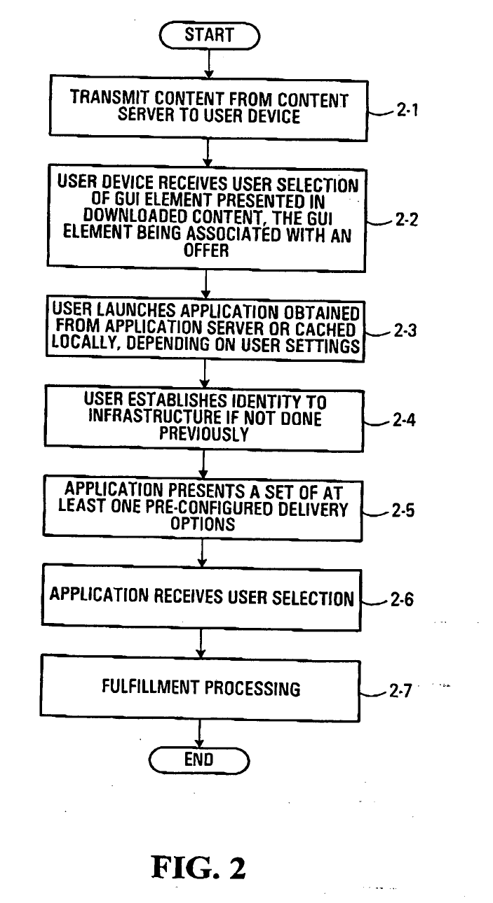

An example of the operation of the system of FIG. 1 will now be described with reference to the flowchart of FIG. 2. Step 2-1 represents the transmission of content from a selected content server to a user device. The content contains one or more GUT elements associated with one or more offers. For a web-based implementation, typically a user would be navigating through various pages available over the internet, and at some point a page that is downloaded will contain the GUI element(s).

At step 2-2, the content is displayed on the user device 24, and the user device receives a user selection of the GUI element presented in the downloaded content, the GUI element being associated with an offer. This may involve “mousing over” the GUI element or actually selecting the GUI element for example. It is contemplated that any mechanism of user selection of the GUI element may be employed. The selection mechanism will typically be a function of the content provided by the content server 20. For example, for a mouse-over implementation, the content delivered by the content server would include the GUI element to be displayed on the user device in a particular location Parameters may be provided as inputs to JavaScript specifying the positioning, size of image and launch location as well as the reaction method (mouse over or click). A javascript.js include file containing the parameters can then be included in the advertiser web page. The include file can be stored on the server and is included when the web page is launched.

At step 2-3, upon receipt of the user selection, the user device launches the application obtained from the application server infrastructure. In some embodiments, it is not necessary to re-launch the application from the server infrastructure each time. Rather local settings can be set that allow the application to be cached locally. A check can then be made to see if the application has been changed, and the application is only re-launched from the server if it has changed. When the application is launched locally, it is still communicating with the application server infrastructure. At step 2-4, the customer establishes their identity to the infrastructure if this has not been done previously. This step can be performed at any time. In a preferred embodiment, the identity establishment is performed through the use of a login functional page forming part of the application that is launched from the application server infrastructure 11. However, other mechanisms of establishing the customer identity may alternatively be employed. Further examples are provided below.

At step 2-5, the application presents a set of at least one pre-configured delivery options on the user device. Examples of delivery options include e-mail, home delivery, office delivery, etc. The particular set of delivery options being presented for a given offer and to a given customer are selected using the set of possible delivery options for the offer contained in the offer information store and the set of at least one delivery options for the customer contained in the customer information store. At step 2-6, the application receives a user selection of one of the set of at least one pre-configured delivery options. This is forwarded to the infrastructure 10, and fulfilment processing occurs at step 2-7. As indicated, this may simply consist of forwarding an order onto an external fulfilment capability.

FIG. 3 is an example of a data structure that might be used for the customer information store 16. Shown is a table having a column 40 for user name, a column 42 for authentication information, a column 44 for delivery options, and a column 46 for any other user-specific information, for example delivery preference. This type of information may be maintained in any suitable form accessible and usable by the application server infrastructure 11. For example, it might be maintained in a database. Furthermore, while a specific structure has been shown, more generally any customer information store that allows an association between users and delivery options and the details of these delivery options is contemplated. In the example records shown in FIG. 3, there is a user having user_name_1. The authentication information 42 consists of a password. The delivery options 44 consist of the details of a home address and an e-mail address, i.e. an actual home address and any e-mail address.

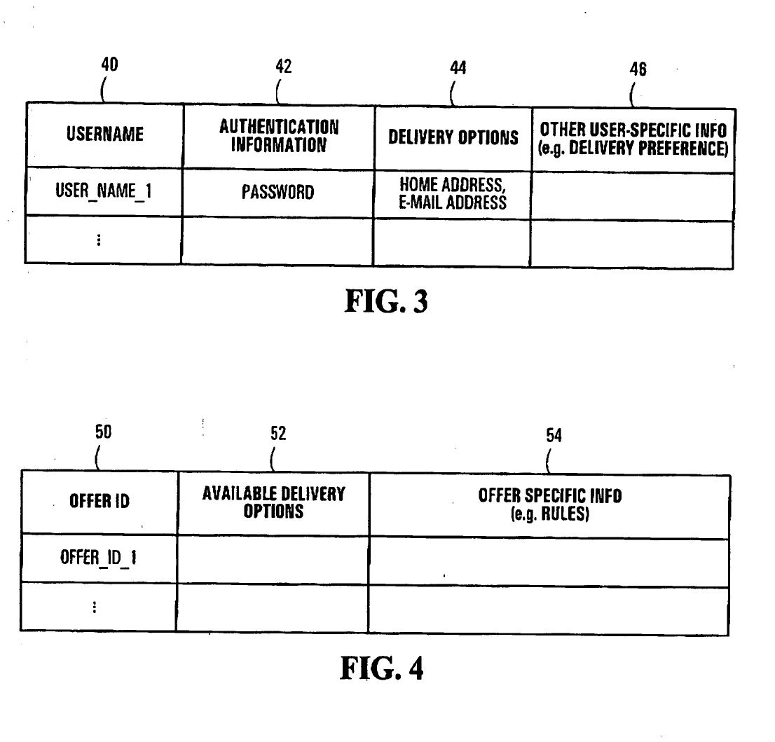

Referring to FIG. 4, shown is an example of how the information in the offer information store 14 might be structured. There is a column 50 for an offer identifier, a column 52 for a list of available delivery options, and a column 54 for any other offer specific information. Preferably, the offer identifier 50 is a unique key word that is associated with each offer and that is included in the content provided by content servers 20 but the offer identifier may take other forms. Thus, a user (or the user device) that downloads a particular content containing an offer will have access to the offer identifier in the form of a key word contained in that content. This key word is then used to index into the information shown in FIG. 4 to obtain the available delivery options 52 and offer specific information 54 if appropriate. In this case, the available delivery options 52 need only specify the possible delivery channels, for example home delivery, electronic delivery, etc. FIG. 4 has been provided to give an example of how the information associating offer identifiers with available delivery options may be achieved. This information might be stored in a database for example. More generally, any suitable offer information store allowing this association to take place may be employed.

The other offer specific information in one embodiment consists of a respective set of rules for each offer. The system is then adapted to apply the set of rules of a given offer when processing the offer. For example, order limits might be imposed with a rule limiting a number of offers that will be fulfilled, or limitations may be placed on deliveries to a given address, postal code or other geographical restriction. Other rules might include age restriction, stock, and expiry dates to name a few examples. In another example, a given offer might be fulfilled differently for different geographical regions that might be identified by province for example. Different versions of a brochure might be delivered to addresses in different provinces. Different fulfilment mechanisms might be selected for addresses in different provinces. The scope of the type of rules that might be included is almost limitless. In some embodiments, the application server infrastructure 11 establishes an ongoing relationship with a user device that outlives a particular interaction associated with an offer. More particularly, after a user of a user device 24 has selected an offer from a particular content server 20, and has established its identity with the application server infrastructure 11, if the same user subsequently selects another offer, either from the same content server or from a different content server, the user identity will still have already been established with the application server infrastructure 11. In a preferred implementation, after a user device 24 has logged in, the application maintains local data that eliminates the need to re-enter login information each time the user selects a new GUI element/offer. Thus, it is important to note that while the user may be navigating through the content of multiple different domains of different content servers, the user does not necessarily have to re-establish its identity with the infrastructure each time it accepts another offer. In some embodiments, the local data that is stored on the user devices 24 is only valid for some period of time. This can be specified in a token for example.

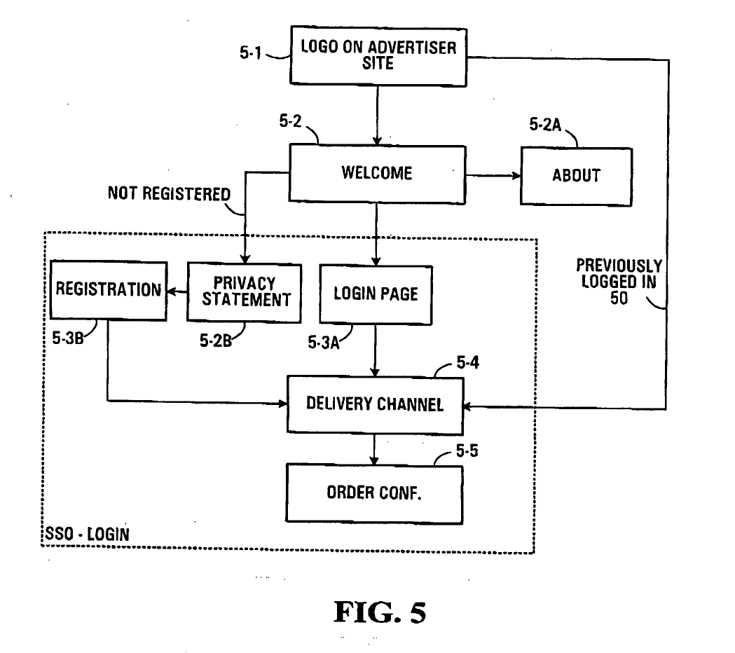

Referring now to FIG. 5, shown is an example of a site map that might be used to implement the application. Shown is a logo on advertisers site 5-1. More generally, this relates to the provision of a GUI element via a content provider. Upon selection of the logo, for example by a mouse over operation, a welcome page 5-2 is displayed. This may for example have an associated “about” page 5-2A that is selectable by a user to obtain further information about fetch. Preferably, the welcome page 5-2 has three options, these being to register (leading to page 5-2B), login (this leading to page 5-3A), or learn more about fetch, this leading to the “about page” 5-2A. If the user selects the login page, then a login page 5-3A is presented. If the registration option is selected, then preferably a privacy statement 5-2B is presented and then a registration page 5-3B is presented. After completion of the login page 5-3A or the registration page 5-3B, the delivery channel page 5-4 is presented. Login will typically include a user entering one or more access parameters which are then processed in accordance with the authentication information in the customer information store and either validated or rejected. This page presents the set of available options associated with this selected offer. In the event the user had previously been logged in to the system, then the process will jump directly from the user selection of the logo to the delivery channel page 5-4 as indicated at 50. An order confirmation page is also shown at 5-5, this being presented after the user has selected the delivery channel using the delivery channel page 5-4.

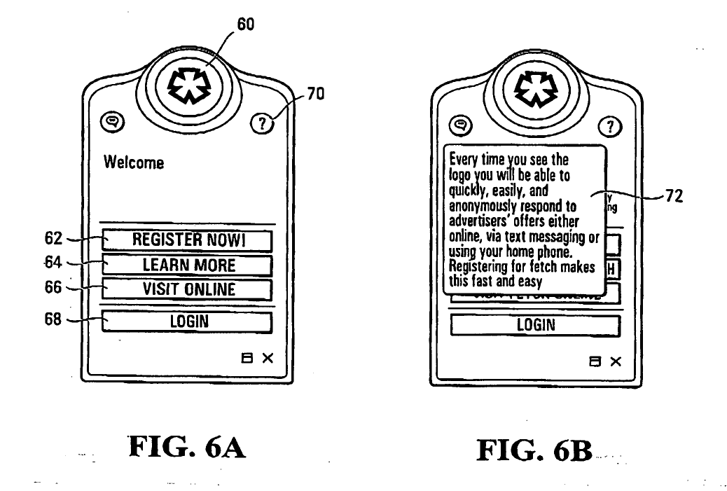

Referring now to FIG. 6A, shown is an example of a welcome page. Preferably, the welcome page and other pages described below fill out around the GUI element displayed by the content provider. In the illustrated example, the GUI element 60 is a circular icon with a small star in the middle. More generally, any appropriate selectable GUI element can be presented. In FIG. 6 the remainder of the welcome page is shown surrounding the GUT element 60, and this is displayed over top of the content downloaded by the content provider. This page includes selectable elements for “register now” 62, “learn more about fetch” 64, “visit on-line” 66, and “login” 68. There is also a question mark element 70 that results in a quick overview of what the functionality is all about is illustrated as shown in FIG. 6B at 72.

In the embodiments described thus far, the only way for a user to access the functionality is to select a GUI element presented by a content provider. In some embodiments, there is an alternative access channel that allows a user to directly contact the application server. If this can be done on-line, then the “visit on-line” element 66 presented in FIG. 6 may be employed. In such a case, the user may login and obtain other information prior to visiting a site containing an offer.

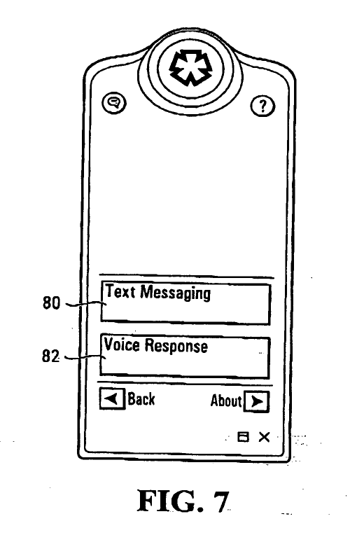

Referring now to FIG. 7, shown are two further examples of how the functionality might be accessed directly without the re-direction from the content provided by the content provider. A first option is accessible on-line, for example after having logged into the site directly. This option, generally indicated at 80 allows a user to simply enter a key word associated with an offer, and then the appropriate available delivery options are generated and presented to the user. Another option 82 is also shown in FIG. 7. However, this is not an on-line implementation. Rather, this presents a phone number to a user that allows a user to call a particular telephone number and enter the key word. In response to the user dialling the number provided and entering the key word an interactive voice response program presents to the user the available delivery channels for selection over the voice channel.

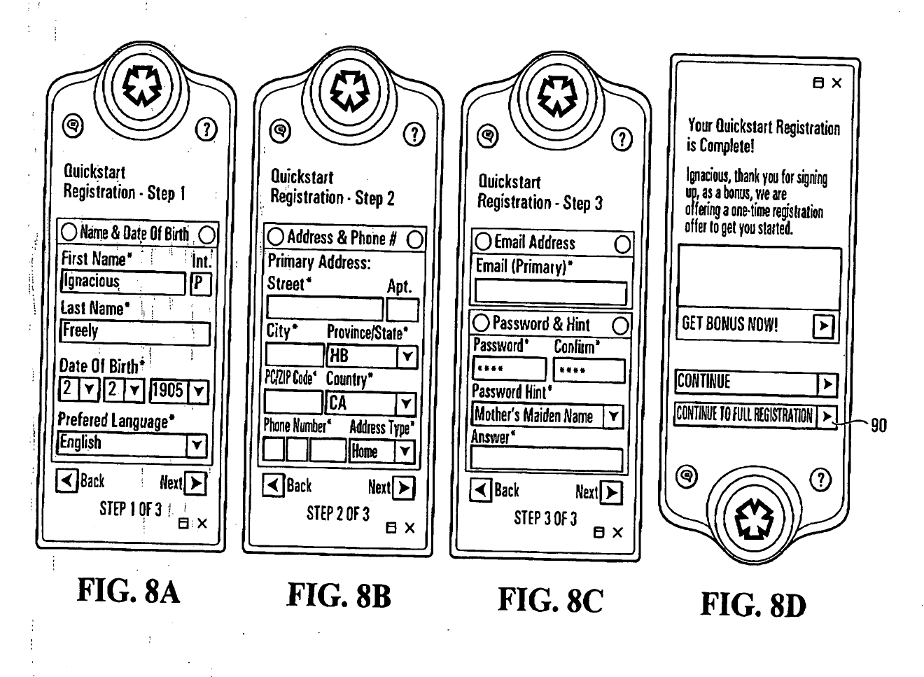

FIGS. 8A, 8B, 8C, and 8D show example displays for performing a “quick start” registration. This is an abbreviated registration process that may be provided. Some embodiments allow a separate more detailed registration to take place. FIG. 8A shows a page for entering name and birthdate and preferred language information. FIG. 8B shows a page for entering home address and telephone number information. FIG. 8C shows a page for entering an e-mail address. Finally, FIG. 8D shows a page for indicating that registration is complete. This page also contains an option 90 to continue on to a more detailed registration. More generally, a registration interface is typically provided that allows a user to specify the available delivery option, and the details of these options.

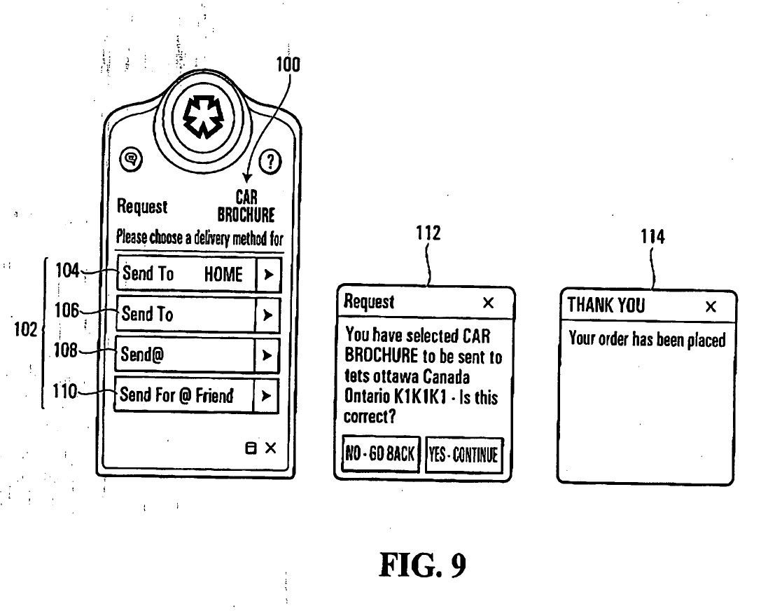

An example of a delivery channel page is shown in FIG. 9. The page shows a name or other identifier for the particular offer 100. In this case, the offer indicates “car brochure”. Then, various delivery options 102 are presented. These include “send to home” 104 which would result in the car brochure being sent to the home address of the user. The next option is “send to” 106 that might relate to a different postal address for example. The next option is “send @” 108 which results in the brochure being delivered by e-mail to the configured e-mail address. The next is “send to @ friend” 110. Once a particular selection has been made, a request confirmation page 112 is presented that allows the user to confirm that the selection is correct, and then a thank you page 114 is displayed. Generally, the options relate to a combination of what the user has pre-registered, and/or options to enter different entries in real time, such as a friend's e-mail address. Another example of a delivery mechanism that might be included as an option is download to a server with e-mail notification and link, or delivery to an electronic device via a channel other than e-mail, for example to a wireless device such as a cell phone or PDA for example that may or may not use e-mail.

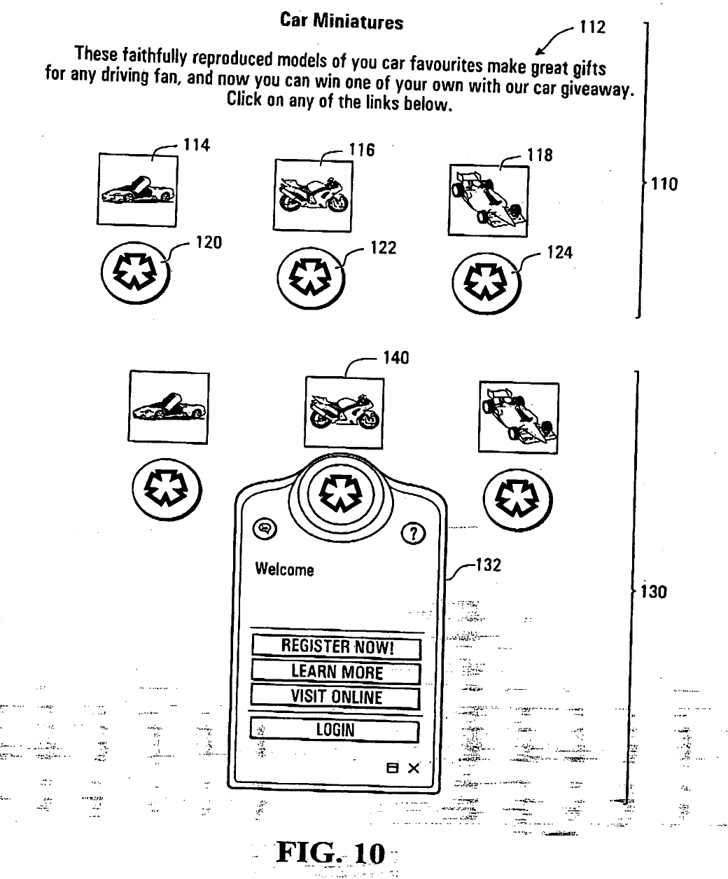

An example of content containing the GUI element is shown in FIG. 10. The content as it is initially displayed is generally indicated at 110. This includes some text 112 describing the offer, and three different offers 114, 116, 118 each having an associated GUI element 120, 122, 124. After the user has selected the GUI element 122 associated with offer 116, the Flash™ application is activated as generally indicated at 130. Here it can be seen that the welcome page 132 fills out around the place where the GUI element 122 had been presented.

In one embodiment of the invention, computer executable instructions for execution by one or more processors are provided, stored on a computer readable medium. When these instructions are executed, the functionality of one or more embodiments of the infrastructure is realized. In another embodiment, the instructions further comprise computer executable instructions that can be used by the content servers to embed the GUI element, and to cause the application to be obtained upon selection of the GUI element upon a user device.

Various embodiments of the invention includes subsets of the functionality described herein. This includes methods, systems and computer readable media relating to maintaining the customer and offer information and providing the launched application, the launched application per se, the server and the server downloadable content per se containing references to the launched application.

For example, one method provided by an embodiment of the invention is a method for execution by a server, such as a web server. The method involves downloading content from the server to a user device, the content including a GUI element associated with an offer. The content also has instructions that cause the user device, upon receiving a selection of the GUI element, to launch a third party application from a different server to select a delivery channel associated with the offer in a manner that protects delivery channel details from being known by the server. In the detailed embodiments described, the third party application is launched in the form of a Flash application, and the user interacts with the third party server to specify the delivery channel for receiving an offer. While this is ongoing, the server that served up the offer in the first place does not know who made the request, and this is good for customer anonymity. The GUI element might for example be associated with the offer through an identifier downloaded as part of the content. Preferably, the third party application is launched over top of the content from the server with the user device not leaving a domain of the content of the server.

Another embodiment provides a computer readable medium having computer executable instructions stored thereon for implementing one of the above summarized methods in a server. Computer readable media can also be provided with the server program and the launched application.

Another embodiment provides a method that involves a first party device interacting with a second party device for online content, the online content including a GUI element having an association with an offer. In the above examples, the first party device is a user device and the second party device is the web server. Upon selection of the GUI element, the first party device using the GUI element's association with the offer to interact with a third party device to launch an application from the third party device over top of the interaction with the second party device. In the above embodiments, the third party device is the server infrastructure. The first party device interacting with the third party device to select a delivery channel for the offer in a manner that protects delivery channel details from being known by said second party device.

Yet another embodiment provides a computer readable medium comprising an application launchable from an application server infrastructure by selection of a GUI element downloaded to a first party device within content provided by a second party server, the application when launched presenting on the first party device a set of at least one delivery options associated with the first party device and associated with an offer associated with the GUI element, and receiving a selection of one of the at least one delivery options and returning this selection to the application server infrastructure in a manner that protects delivery channel details from being known by said second party server.

Numerous modifications and variations of the present invention are possible in light of the above teachings. It is therefore to be understood that within the scope of the appended claims, the invention may be practiced otherwise than as specifically described herein.

1. A system comprising:
application server infrastructure adapted to deliver an application over a network for execution on a user device;
a customer information store adapted to maintain details of a respective set of at least one delivery option for each of a plurality of customers;
an offer information store adapted to maintain a respective set of possible delivery options for each of a plurality of offers;
wherein the application, upon being launched by the user device, presents on the user device a set of at least one delivery option, the set of at least one delivery option being determined using the set of possible delivery options for a selected offer and the set of at least one delivery options for the customer, collects a selection of one of the at least one delivery options and returns this selection to the application server infrastructure.

2. The system of claim 1 in combination with a plurality of content servers for delivering on-line content to customers using user devices via a network, the on-line content comprising at least one offer of said plurality of offers, each offer associated with a selectable GUI element that upon selection launches the application from the infrastructure.

3. The system of claim 2 wherein the plurality of content servers are on a plurality of different domains.

4. The system of claim 1 wherein the application provides rich interactive media.

5. The system of claim 4 wherein the application is a Flash application.

6. The system of claim 4 wherein the application is selected from a group consisting of:
a browser plug-in based application;
an application that does not rely on a browser;
an application using BREW or Java 2 Micro Edition (J2ME);
an application using Active X controls, JavaScript, Flex, Xforms or Shockwave.

7. The system of claim 1 further comprising:
a registration interface through which a customer registers with the system, is given access parameters and can input details of their delivery options.

8. The system of claim 4 wherein the registration interface is part of the application.

9. The system of claim 1 wherein the available delivery options comprise at least one of:
physical delivery to a postal address;
delivery to an e-mail address; and
delivery to a download location with e-mail notification and link;
delivery to an electronic device via a channel other than e-mail.

10. The system of claim 1 wherein:
the application comprises a login function adapted to collect and authenticate access parameters.

11. The system of claim 10 wherein the application is further adapted to maintain local data associated with the server infrastructure to the user device after successful login such that subsequent operations do not require a repeat login operation.

12. The system of claim 11 wherein the local data comprises a token having an expiry time.

13. The system of claim 1 further comprising:
fulfilment infrastructure adapted to perform a delivery in accordance with the selected offer and the selected delivery option.

14. The system of claim 2 wherein the application, when launched, collects the selections of one or more delivery channels in a manner that protects delivery channel details from being known by said content servers.

15. The system of claim 1 adapted to generate an order identifying the offer and delivery details and to forward this to an external fulfilment capability.

16. The system of claim 2 wherein each selectable GUI element has an associated identifier that indexes into the offer information store.

17. The system of claim 1 wherein the application further presents static information identifying at least one other channel through which offers can be accessed.

18. The system of claim 1 wherein the offer information store further comprises a respective set of rules for each offer, the system being adapted to apply the set of rules of a given offer when processing the offer.

19. The system of claim 18 wherein at least one set of rules includes at least one rule selected from a group consisting of:
order limits;
geographical restrictions;
restrictions on different fulfilments to different postal codes;
age restrictions,
inventory restriction.

20. A computer executable method comprising:
storing details of a respective set of at least one delivery option for each of a plurality of customers;
storing a respective set of possible delivery options for each of a plurality of offers;
receiving from a particular customer an input specifying a selected offer, the selected offer having been presented in third party content downloaded from a third party;
determining a set of at least one delivery options in respect of the selected offer and the particular customer;
delivering an application over a network for execution on the user device that when executed presents the set of at least one delivery options in respect of the selected offer and the particular customer;
receiving a selection of one of the at least one delivery options.

21. The computer executable method of claim 20 further comprising:
determining the particular user through a login procedure.

22. The computer executable method of claim 20 wherein the application is an application that provides rich interactive media.

23. The computer executable method of claim 22 wherein the application is a Flash application.

24. The computer executable medium of claim 22 wherein the application is selected from a group consisting of:
a browser plug-in based application;
an application that does not rely on a browser;
an application using BREW or Java 2 Micro Edition (J2ME);
an application using Active X controls, JavaScript, Flex, Xforms or Shockwave.

25. The computer executable method of claim 20 further comprising:
presenting a registration interface through which a customer registers, and can input details of their delivery options.

26. The computer executable method of claim 20 wherein the application maintains local data such that subsequent operations do not require a repeat login operation.

27. The computer executable method of claim 26 further adapted to generate an order identifying the offer and the delivery details, and to forward this to an external fulfilment capability.

28. The computer executable method of claim 20 further comprising storing a respective set of rules for each offer, and applying the set of rules of a given offer when processing each offer.

29. A computer readable medium having processor executable instructions stored thereon for implementing the method according to claim 20.

30. A method in a server comprising:
downloading content from the server to a user device, the content including a GUT element associated with an offer, wherein the content comprises instructions that cause the user device, upon receiving a selection of the GUI element, to launch a third party application from a different server to select a delivery channel associated with the offer in a manner that protects delivery channel details from being known by the server.

31. The method of claim 30 wherein the GUI element is associated with the offer through an identifier downloaded as part of the content.

32. The method of claim 30 wherein the third party application is launched over top of the content from the server with the user device not leaving a domain of the content of the server.

33. A computer readable medium having computer executable instructions stored thereon for implementing the method of claim 30.

34. A computer readable medium according to claim 33 in combination with a second computer readable medium comprising said third party application.

35. A method comprising:
a first party device interacting with a second party device for online content, the online content including a GUI element having an association with an offer;
upon selection of the GUI element, the first party device using the GUI element's association with the offer to interact with a third party device to launch an application from the third party device over top of the interaction with the second party device;
the first party device interacting with the third party device to select a delivery channel for the offer in a manner that protects delivery channel details from being known by said second party device.

36. A computer readable medium comprising an application launchable from an application server infrastructure by selection of a GUI element downloaded to a first party device within content provided by a second party server, the application when launched:
presenting on the first party device a set of at least one delivery options associated with the first party device and associated with an offer associated with the GUI element;
receiving a selection of one of the at least one delivery options and returning this selection to the application server infrastructure in a manner that protects delivery channel details from being known by said second party server.
